(19) United States
(12) Patent Application Publication
(10) Pub. No.: US 2020/0009613 A1
(43) Pub. Date: Jan. 9, 2020

(54) SILICONE COATINGS FOR EXTERIOR ARCHITECTURAL SUBSTRATES FOR BUILDINGS

(71) Applicant: Industrial Control Development, Inc., Ridgefield, WA (US)

(72) Inventors: John W. Swanson, Lake Oswego, OR (US); Larry Vockler, Vancouver, WA (US); Kris Vockler, Ridgefield, WA (US); Timothy Krytenberg, Ridgefield, WA (US)

(73) Assignee: Industrial Control Development, Inc., Ridgefield, WA (US)

(21) Appl. No.: 16/030,708

(22) Filed: Jul. 9, 2018

(51) Int. Cl. B05D 5/06; H02S 40/22

(52) U.S. Cl. CPC B05D 5/063; H02S 40/22; B05D 2203/35; E04B 2001/7691; B05D 2520/00; B05D 2601/24; B05D 2518/10

(57) ABSTRACT

A method comprising applying a reflective silicone-containing composition to at least a portion of a surface of at least one architectural substrate, wherein the silicone-containing composition-applied surface faces an exterior wall of a building or an exterior roof of a building.

### BACKGROUND

Roof top photovoltaic (PV) solar panels are becoming increasingly common as the renewable energy market continues to grow worldwide. PV panels are typically supplied in a metal framed housing with a glass top having a surface area in the general range of 1 to 2 square meters to allow installation without difficulty. The PV panels are secured to the exterior of the building roof and/or wall using mounting grids including electrical connections to capture the energy produced from the PV panels.

### SUMMARY

Disclosed herein are methods comprising:

applying a reflective silicone-containing composition to at least a portion of a surface of at least one architectural substrate, wherein the silicone-containing composition-applied surface faces an exterior wall of a building or an exterior roof of a building.

Also disclosed herein are methods comprising:

applying a reflective silicone-containing composition to at least a portion of an interior surface of a spandrel glass substrate, wherein the spandrel glass substrate includes at least one photovoltaic cell.

Additionally disclosed herein are methods comprising applying a colored silicone-containing composition to at least a portion of an interior surface of a glass substrate, wherein the glass substrate includes at least one photovoltaic cell and the color is a color other than white.

Further disclosed herein is a building structure comprising:

an exterior wall having an exterior surface and an interior surface;

at least one architectural substrate secured to the exterior wall of the building, wherein the architectural substrate has an interior surface facing the exterior surface of the exterior wall of the building and an outdoor-facing exterior surface; and a reflective silicone coating disposed on at least a portion of the interior surface of the architectural substrate.

Additionally disclosed herein is a building structure comprising:

a spandrel glass substrate having an interior surface and an external surface, and which includes at least one photovoltaic cell;

an insulation layer inward from the spandrel glass substrate;

a void cavity interposed between the interior surface of the spandrel glass substrate; and

a reflective silicone coating disposed on at least a portion of the interior surface of the spandrel glass substrate.

The foregoing will become more apparent from the following detailed description, which proceeds with reference to the accompanying figures.

### BRIEF DESCRIPTION OF THE DRAWINGS

FIG. 1 a three-dimensional view a building support wall that includes exterior panels with a silicone-containing coating.

FIG. 2 is a cross-section view of spandrel cavity of a building that shows an illustrative location of a silicone-containing coating.

### DETAILED DESCRIPTION

Disclosed herein are methods for applying a silicone-containing composition to the surface of an architectural substrate. In certain embodiments, the substrate is an architectural panel for an outside exterior of a building such as a ceramic or glass panel, a ceramic or glass siding, or a ceramic or glass roof cladding. The panel, siding or cladding is attached to the outside exterior surface of a support wall or roof of the building. In certain embodiments, the panel(s) is part of the exterior envelope of the building. The composition is applied to the surface of the exterior panel, siding or cladding facing the exterior surface of the support wall or roof (i.e., the interior-facing surface of the exterior panel, siding or cladding).

In certain embodiments, the silicone-containing composition can be applied to any panel, siding or cladding covering an industrial, commercial or residential building.

In certain embodiments, the silicone-containing composition can be applied to a surface on the bottom side (i.e., the side of the roof cladding that faces the roof) of transparent or semi-transparent roof cladding. The roof cladding may also support at least one photovoltaic cell. In this embodiment, the silicone-containing composition is pigmented to impart a color to the composition.

For example, typical PV panels are not offered in multiple colors and considered unattractive by much of the public. Silicone-containing compositions can resolve this issue by applying the compositions as coatings to the PV panels to provide color and opacity to commercial buildings. Silicone-containing coatings applied appropriately can also provide fallout protection (retains glass if broken). Silicone-containing coatings do not weaken glass whereas ceramic enamel, also used to provide color and opacity to the exterior of buildings, has been found to weaken glass substantially. PV's attached to glass substrates or fabricated on the glass can be spaced or oriented to allow portions of colored silicone-containing coating to show through to the front of glass substrates between spaced PVs. Alternatively, translucent PVs would allow colored silicone-containing coating to be seen through the PVs thereby offering some color options for the roof and or exterior walls of building structures.

In certain embodiments, the silicone-containing compositions may impart glass or ceramic containment if the substrate (e.g., a roof cladding or siding) is damaged in a storm (e.g., a hailstorm).

The silicone-containing compositions as applied to the substrates as disclosed herein can increase reflectivity in the ultraviolet and/or visible and/or infrared wavelength ranges of the electromagnetic spectrum. Applying silicone-containing compositions in the locations as disclosed herein can enhance photovoltaic efficiency used for electrical power generation for industrial, commercial and residential site applications. In certain embodiments, the silicone-containing composition is applied to the substrate such that the application surface is facing and closest to the industrial, commercial or residential building structure so as to not obstruct incident sunlight from reaching a photovoltaic cell or panel.

In certain embodiments, the composition for applying to the substrate includes a silicone water-based elastomer. The silicone water-based elastomer is an emulsion that coalesces as the water is removed (e.g., via evaporation).

In certain embodiments, the composition includes include a liquid silicone elastomer. The liquid silicone elastomer may be 100% solids or diluted with a solvent(s).

In certain embodiments, silicone is the only film-forming polymer present in the composition.

In certain embodiments, the silicone is present in the composition in an amount of 5 to 90, more particularly 25 to 75, weight percent based on total composition weight including water and/or solvent.

In certain embodiments, the composition includes at least one pigment. The pigment may provide a color to the cured composition.

In certain embodiments, the composition includes at least one pigment or other additive that imparts reflectivity when the composition is cured. Illustrative reflectivity pigments/additives include titanium dioxide (e.g., rutile or anatase, with rutile as preferred), reflective metallic particles (e.g., reflective mica (e.g., Xirallic T-61-10WNT), micro silver, zinc oxide (e.g., zinc oxide A2066), and surface reflective additives that use contrasting refractive index to modulate reflectivity. The amount of the reflectivity pigment/additive may range, for example, from 3 to 50, more particularly 15 to 35, weight percent based on total composition weight including water and/or solvent.

In certain embodiments, the composition may include a color-imparting additive (e.g., a color pigment) to provide a desired color (including black) to the substrate (e.g., the surface of a glass or ceramic substrate). In certain embodiments, the colored silicone-containing composition is a color other than white. In certain embodiments, the colored silicone-containing composition is black. In certain embodiments, the colored silicone-containing composition is a color other than black or white. Illustrative color pigments include:

| Color | Pigment | C.I. Pigment | CAS # | Manufacturer | Pigment type |
|---|---|---|---|---|---|
| Black | Nubifer NB- | | | Nubiola/Ferro | iron oxides |
| | 5970 | | | | |
| Black | Monarch 1000 | | | Cabot | carbon black |
| Black | 303T | Bayferrox ® | 68186- | | iron and manganese oxide |
| | | 303 T | 94-7 | | (Fe,Mn)₂0₃ |
| White | 1000 | Kronos 1000 | 13463- | | titanium dioxide |
| | | | 67-7 | | |
| Brown | Brown 10P850 | Yellow 164 | | Shepherd | Manganese Antimony Titanium Buff |
| | | | | | Rucladding |
| Yellow | Nubifer Y- | | | Nubiola/Ferro | iron oxides |
| | 7050 | | | | |
| Yellow | 30C236 | Brown 24 | 68186- | | Chromium antimony and titanium |
| | | | 90-3 | | |
| Blue | Blue 385 | Blue 28 | 1345-16- | Shepherd | Cobalt Aluminate Blue Spinel |
| | | | 0 | | |
| Blue | Blue 211 | Blue 36 | 68187- | Shepherd | Cobalt Chromite Blue-Green Spinel |
| | | | 11-1 | | |
| Blue | 214 | Blue 28 | 1345-16- | Shepherd | Cobalt and aluminum |
| | | | 0 | | |
| Red | nubifer R- | | | Nubiola/Ferro | iron oxides |
| | 5501 | | | | |
| Green | SMM Chrome | | | Nubiola/Ferro | Chrome oxide |
| | oxide | | | | |
| Green | Green 223 | Green 50 | | Shepherd | Cobalt Titanate Green Spinel |

The composition provides good UV resistance, and adhesion to glass and ceramic substrates.

In certain embodiments, the cured composition residing on the substrate surface has a reflectivity of first surface range (L* specular excluded) of 90 to 99, L*=95 to 97. The reflectivity is measured using an X-Rite Color i7 spectrophotometer. The reflectivity is based on setting: RFL/LAV SCE (reflectance/lightness where “A” relates to green and red and “V” relates to blue and yellow and SCE is specular component excluded. The first surface is defined as the first surface that the sunlight encounters. As an example, the window surfaces for a double pane window are defined as first, second, third and fourth surfaces where the first surface is the first surface the sunlight encounters. The opposing side of the first surface is the second surface of the first glass pane. The sunlight then encounters the third surface (second glass pane) and lastly the fourth surface (second glass pane). The fourth glass surface is the innermost glass surface in the interior of a building.

In certain embodiments, the cured and/or dried composition has a Shore A hardness of 33 to 45, a tensile strength of 300 to 1000 psi (measured per ASTM D-412), an elongation at break of 500 to 1000%, a cross hatch adhesion of 5B per ASTM 3359, and/or adhesion pull resistance averaging 430 psi per ASTM D4541.

In certain embodiments, the applying (e.g., coating) conditions are at ambient temperature and humidity. The silicone-coating compositions may be applied at the industrial, commercial or residential building site or they may be applied at the substrate manufacturing facility.

In certain embodiments, the coating thickness may be 3 to 14 mils, more particularly 6 to 10 mils.

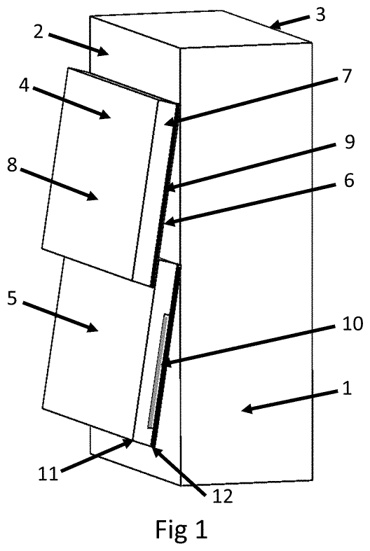

An illustrative example of an application of silicone-containing compositions is shown in FIG. 1. FIG. 1 shows an exterior building wall 1, which may be a support or load-bearing wall. An exterior surface 2 of wall 1 faces the outdoor environment. An interior surface 3 of wall 1 faces the interior of the building. At least one exterior substrate (e.g., a panel) is secured to the exterior surface 2 of the wall 1. FIG. 1 shows a first exterior panel 4 and a second exterior panel 5 to illustrate two embodiments of the location of a silicone-containing coating 6.

The first exterior panel 4 includes a substrate 7 (e.g., glass or ceramic substrate) and has an exterior surface 8 and an interior surface 9. The interior surface 9 of the panel 4 faces the exterior surface 2 of the wall 1. A silicone-containing composition is applied to at least a portion of the interior surface 9 to form the silicone coating 6. Thus, the silicone coating 6 is interposed between the interior surface 9 of the panel 4 and the exterior surface 2 of the wall 1.

The second exterior panel 5 includes a photovoltaic cell 10. The panel 5 has an exterior surface 11 and an interior surface 12. The interior surface 12 of the panel 5 faces the exterior surface 2 of the wall 1. A silicone-containing composition is applied to at least a portion of the interior surface 12, including the photovoltaic cell 10, to form the silicone coating 6. Thus, the silicone coating 6 is interposed between the interior surface 12 of the panel 5 and the exterior surface 2 of the wall 1, and the silicone coating 6 is interposed between the photovoltaic cell 10 and the exterior surface of the wall 1. In certain embodiments, at least a portion of the silicone coating 6 contacts the exterior surface 2 of the wall 1.

In certain embodiments, the building configuration may include only glass and/or ceramic panels 4. In certain embodiments, the building configuration may include only photovoltaic panels 5. In certain embodiments, the building configuration may include both glass and/or ceramic panels 4 and photovoltaic panels 5.

The silicone-coated panels 4 and/or 5 may be placed on any external part of the building, including the roof.

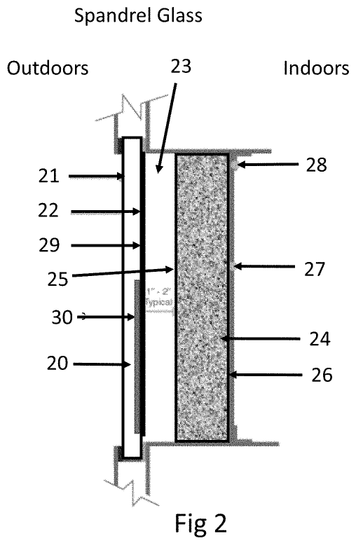

A further illustrative example of an application of silicone-containing compositions is shown in FIG. 2. FIG. 2 shows a spandrel glass application of the silicone-containing composition. A spandrel glass substrate 20 for the exterior of a building has an exterior surface 21 and an interior surface 22. The building wall structure may also include a layer of insulation 24 having an exterior surface 25 and an interior surface 26. A vapor barrier 27 is disposed on the interior surface 26 of the insulation 24. A tape 28 or other securing method is provided for securing the insulation to the building wall structure. A void cavity 23 is interposed between the interior surface 22 of the spandrel glass substrate 20 and the exterior surface 25 of the insulation 24.

A silicone-containing composition is applied to at least a portion of the interior surface 22 of the spandrel glass substrate 20 to form a silicone coating 29. Thus, the silicone coating 29 faces the cavity 23. A photovoltaic cell 30 may also be disposed on at least a portion of the interior surface 22 of the spandrel glass substrate 20. In this embodiment the silicone coating 29 is also interposed between the photovoltaic cell 30 and the cavity 23.

In view of the many possible embodiments to which the principles of the disclosed invention may be applied, it should be recognized that the illustrated embodiments are only preferred examples of the invention and should not be taken as limiting the scope of the invention.

What is claimed is:

1. A method comprising:
applying a reflective silicone-containing composition to at least a portion of a surface of at least one architectural substrate, wherein the silicone-containing composition-applied surface faces an exterior wall of a building or an exterior roof of a building.

2. The method of claim 1, wherein the silicone is a silicone water-based elastomer or a liquid silicone elastomer.

3. The method of claim 1, wherein the architectural substrate is a panel secured to the exterior wall of a building.

4. The method of claim 1, wherein the architectural substrate is a ceramic panel.

5. The method of claim 1, wherein the architectural substrate is a glass panel.

6. The method of claim 1, wherein the architectural substrate is a roof panel.

7. The method of claim 1, wherein the architectural substrate includes at least one photovoltaic cell.

8. The method of claim 1, further comprising curing the reflective silicone-containing composition to a form reflective silicone coating.

9. The method of claim 1, further comprising drying the reflective silicone-containing composition to a form reflective silicone coating.

10. The method of claim 8, wherein at least a portion of the reflective silicone coating contacts the exterior wall of the building or the exterior roof of the building.

11. The method of claim 1, wherein the reflective silicone-containing composition also includes at least one pigment that imparts reflectivity in the ultraviolet and/or visible and/or infrared wavelength range.

12. The method of claim 11, wherein the pigment is titanium dioxide.

13. The method of claim 1, wherein the reflective silicone-containing composition is a water-based silicone emulsion

14. A method comprising:
applying a reflective silicone-containing composition to at least a portion of an interior surface of a spandrel glass substrate, wherein the spandrel glass substrate includes at least one photovoltaic cell.

15. The method of claim 14, wherein the reflective silicone-containing composition coats at least a portion of the photovoltaic cell.

16. The method of claim 14, wherein the reflective silicone-containing composition also includes at least one pigment that imparts a color to the composition.

17. The method of claim 14, wherein the reflective silicone-containing composition also includes at least one pigment that imparts reflectivity in the ultraviolet and/or visible and/or infrared wavelength range.

18. A method comprising:
applying a colored silicone-containing composition to at least a portion of an interior surface of a glass substrate, wherein the glass substrate includes at least one photovoltaic cell and the color is a color other than white.

19. The method of claim 18, further comprising attaching the glass substrate to an exterior of a building such that the interior surface of the glass substrate is facing the exterior of the building.

20. The method of claim 18, wherein the glass substrate is a transparent roof panel.

21. The method of claim 18, wherein the colored silicone-containing composition is black.

22. The method of claim 18, wherein the colored silicone-containing composition is a color other than black.

23. A building structure comprising:
an exterior wall having an exterior surface and an interior surface;
at least one architectural substrate secured to the exterior wall of the building, wherein the architectural substrate has an interior surface facing the exterior surface of the exterior wall of the building and an outdoor-facing exterior surface; and
a reflective silicone coating disposed on at least a portion of the interior surface of the architectural substrate.

24. The structure of claim 23, wherein the architectural substrate is a ceramic panel.

25. The structure of claim 24, wherein the architectural substrate is a glass panel.

26. The structure of claim 23, wherein the architectural substrate includes at least one photovoltaic cell.

27. A building structure comprising:
a spandrel glass substrate having an interior surface and an external surface, and which includes at least one photovoltaic cell;
an insulation layer inward from the spandrel glass substrate;
a void cavity interposed between the interior surface of the spandrel glass substrate; and
a reflective silicone coating disposed on at least a portion of the interior surface of the spandrel glass substrate.

28. The structure of claim 27, wherein the reflective silicone coating is disposed on at least a portion of the photovoltaic cell.
